(19) United States
(12) Patent Application Publication
(10) Pub. No.: US 2012/0178556 A1
(43) Pub. Date: Jul. 12, 2012

(54) HOCKEY STICK

(75) Inventors: Rémi LUSSIER, Drummondville (CA); Marcel JEAN, Drummondville (CA); Daniel GATIEN, Drummondville (CA); Germain BÉLANGER, St-Germain-De-Grantham (CA)

(73) Assignee: 2946-6380 QUEBEC INC. a/s Productions P.H. Enr., Drummondville (CA)

(21) Appl. No.: 13/211,623

(22) Filed: Aug. 17, 2011

Related U.S. Application Data
(60) Provisional application No. 61/430,360, filed on Jan. 6, 2011.

(51) Int. Cl. A63B 59/14; B23P 17/04

(52) U.S. Cl. 473/561; 473/560; 29/592

(57) ABSTRACT

A hockey stick shaft of a generally rectangular cross section and a varying rigidity along its length, from a distal end portion thereof to a proximate end portion thereof, comprising an exterior wall, the exterior wall being locally deformed towards an inside of the shaft, and a method for producing a shaft having a varying rigidity along a length thereof, comprising providing a shaft in a high rigidity composite material, of a generally rectangular cross sectional envelope; and selectively forming at least one embossed groove in at least one surface of the shaft.

### CROSS REFERENCE TO RELATED APPLICATIONS

This application claims benefit of U.S. provisional application Ser. No. 61/430,360, filed on Jan. 6, 2011. All documents above are incorporated herein in their entirety by reference.

### FIELD OF THE INVENTION

The present invention relates to hockey sticks.

### BACKGROUND

A hockey shaft should be very rigid, for mechanical resistance and maximum performances during slap shots for example. However, in order to be able to store energy and transfer this energy back to the hockey puck, a hockey shaft also needs to be sufficiently flexible. Very rigid shafts prove to have a high mechanical resistance but may lack such flexibility.

Efforts have been made to locally modify the rigidity of a hockey stick shaft by locally modifying the thickness of the walls of the shaft, and/or by shortening some of the layers of fibers within the laminated walls of the shaft, and/or by reducing the ratio fiber/resin within the material of the shaft for example. However, such modifications result in localized reduced mechanical resistance, i.e. in weakened points or zones in the shaft, where localized breakage of the shaft may occur.

There is still a need in the art for a shaft overcoming the shortcomings of the prior art.

### SUMMARY OF THE INVENTION

More specifically, in accordance with the present invention, there is provided a hockey stick shaft of a generally rectangular cross section and a varying rigidity along its length, from a distal end portion thereof to a proximate end portion thereof, comprising an exterior wall, the exterior wall being locally deformed towards an inside of the shaft.

There is further provided a method for producing a shaft having a varying rigidity along a length thereof, comprising providing a shaft in a high rigidity composite material, of a generally rectangular cross sectional envelope; and selectively forming at least one embossed groove in at least one surface of the shaft.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1a) is a side view of a shaft according to an embodiment of an aspect of the present invention; 1b)-1f) are sections views of the shaft of FIG. 1a); FIG. 1g) is another side view of the shaft of FIG. 1a); and FIG. 1h) is a perspective view of the shaft of FIG. 1a);

FIG. 2a) shows a detail of a shaft according to an embodiment of an aspect of the present invention; 2b) show sections of shafts according to embodiments of an aspect of the present invention; FIG. 2c) shows first orientation of grooves of a shaft according to an embodiment of an aspect of the present invention; and FIG. 2d) shows second orientation of grooves of a shaft according to an embodiment of an aspect of the present invention;

FIGS. 3a)-3d) show details of grooves according to embodiments of an aspect of the present invention;

FIGS. 4a)-4j) show examples of geometries of grooves according to embodiments of an aspect of the present invention;

FIG. 5 shows a 3 points flexion test set up;

FIGS. 6a)-6d) show how the linear rigidity of a shafts may be varied according to embodiments of an aspect of the present invention; and

FIGS. 7a)-7c) show a combination of grooves according to an embodiment of an aspect of the present invention.

### DESCRIPTION OF EMBODIMENTS OF THE INVENTION

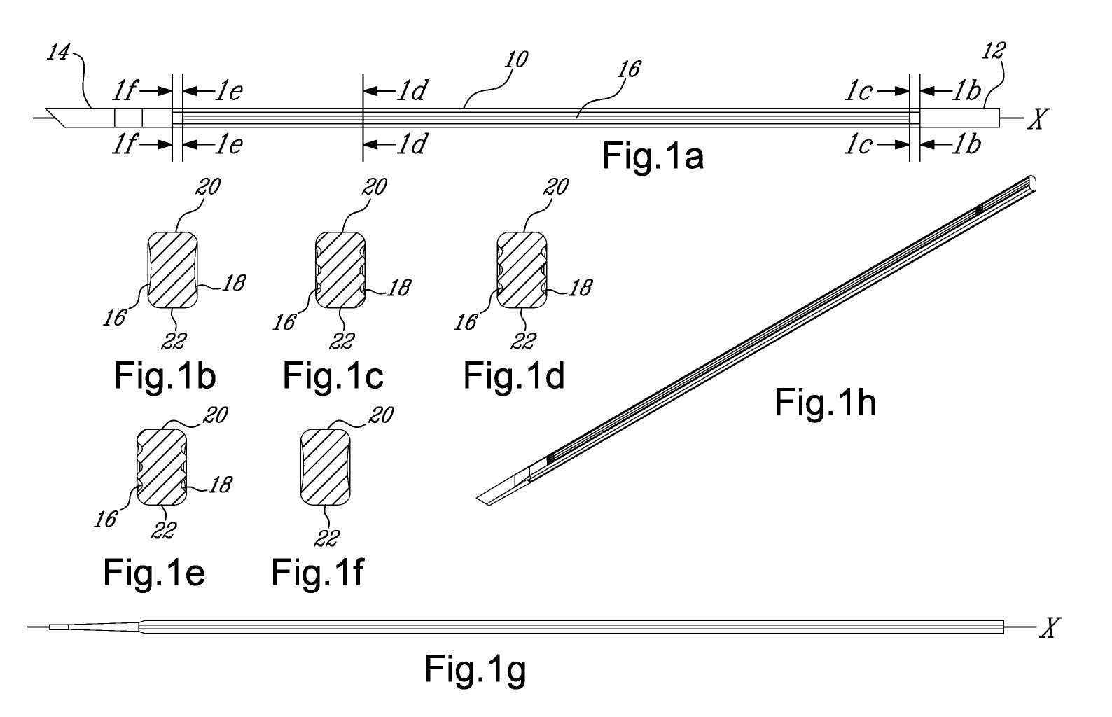

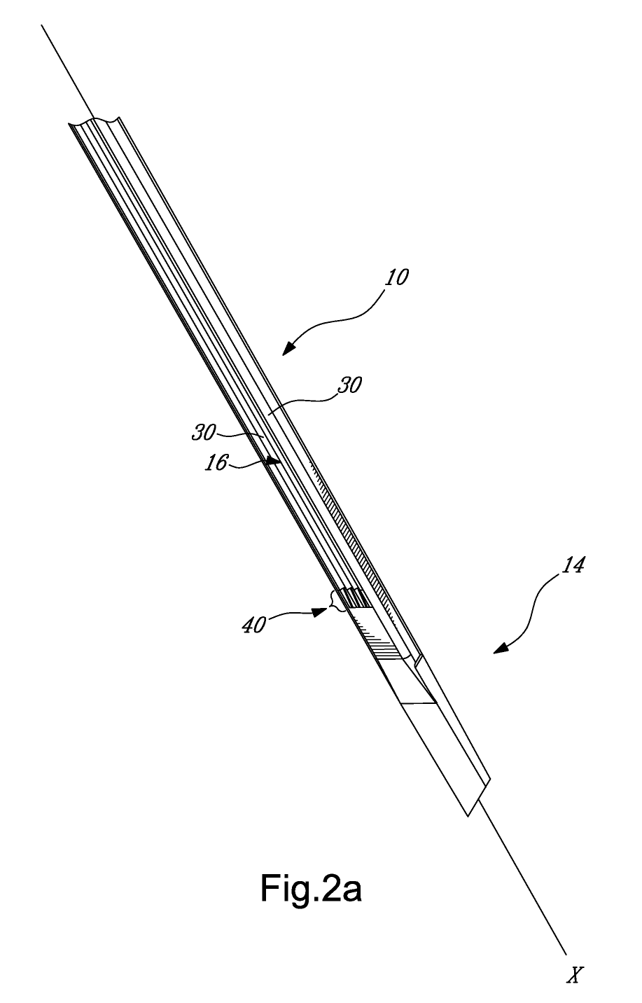

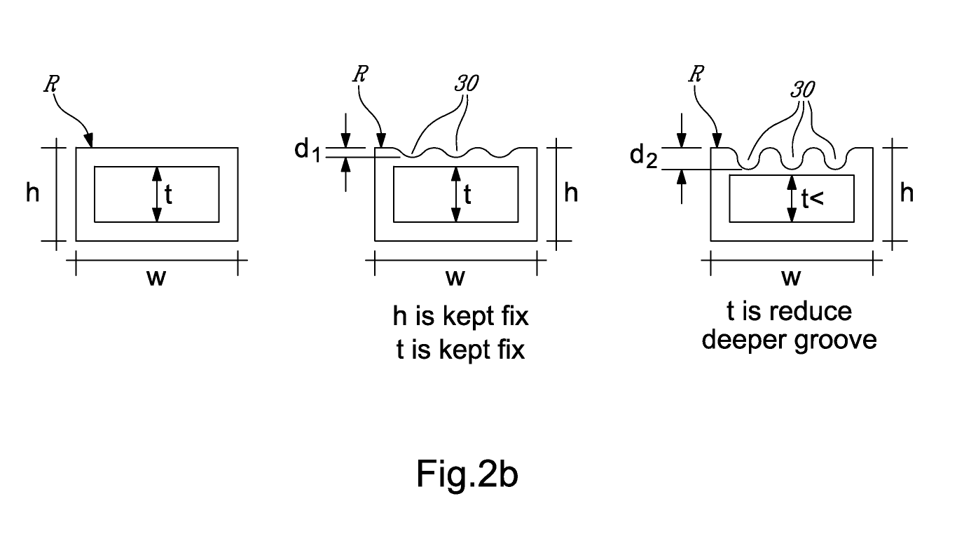

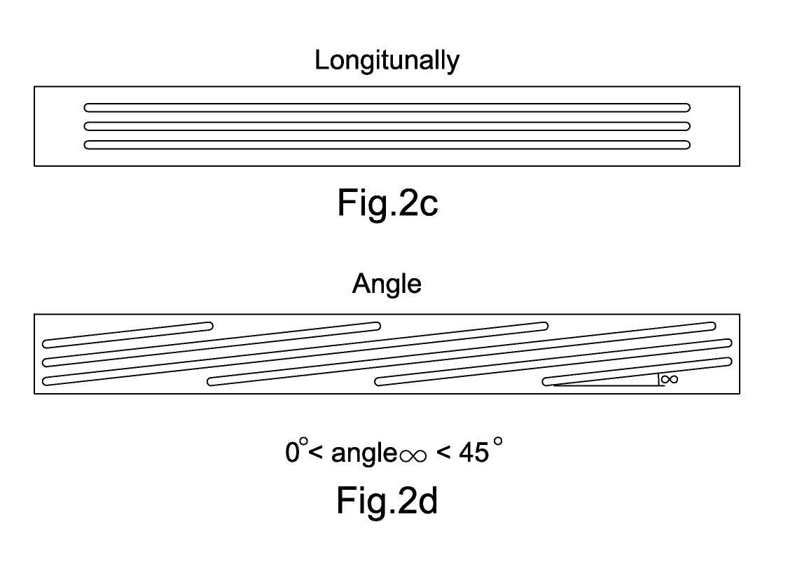

As illustrated in FIGS. 1-3, a hockey stick shaft 10 according to an embodiment of an aspect of the present invention has a generally rectangular cross sectional envelope (see FIGS. 1b-1f for example), with a tapering distal end portion 14 for attachment of a blade (not shown) and a proximate end portion 12, wide faces 16 and 18 of a height (h) and width (w) (see FIG. 2b) and narrow top and bottom faces 20 and 22.

In FIG. 2b, the wide face 16 is shown with deformations towards the inside of the shaft, such as grooves 30. The grooves 30 are integrally embossed within the material of the wall of the face 16. They are entirely built within the rectangular transverse profile (R) of height (h) and width (w) of the shaft 10, as best seen in FIGS. 1c, 1d, 2b, 3a and 3b for example, thereby maintaining the integrity of the rectangular cross sectional envelope (R): the thickness (t) of the empty core of the shaft either remains unchanged (see middle FIG. 2b), or is reduced in case of deeper grooves 30, of depth d₂>d₁ (see right hand side in FIG. 2b) with the height (h) of the shaft 10 constant.

The grooves 30 extend along at least parts of the length of the shaft 10 between the distal end portion 14 and the proximate end portion 12. The grooves 30 may be provided at every 4 to 6 inches along the length of the shaft. They may be generally longitudinally oriented (see FIG. 2c for example) or comprise lengths having an angle alpha relative to the longitudinal axis (X) of the shaft 10, with the angle alpha comprised between 0 and 45° for example (see FIG. 2d for example).

The grooves 30 may be localized on any of the faces of the shaft depending on the desired results. For example, grooves 30 on the front and/or rear faces of the shaft, i.e. on wide faces 16 and 18, are found to decrease the rigidity of the shaft during a shot, while grooves 30 on the top and/or bottom faces of the shaft 20 and 22, are found to improve the resistance to slashing or reverse slashing, i.e. resistance to transverse impact submitted to the top and/or bottom faces of the shaft when localized filaments or wires for example are embedded or incorporated on the top and/or bottom faces of the shaft.

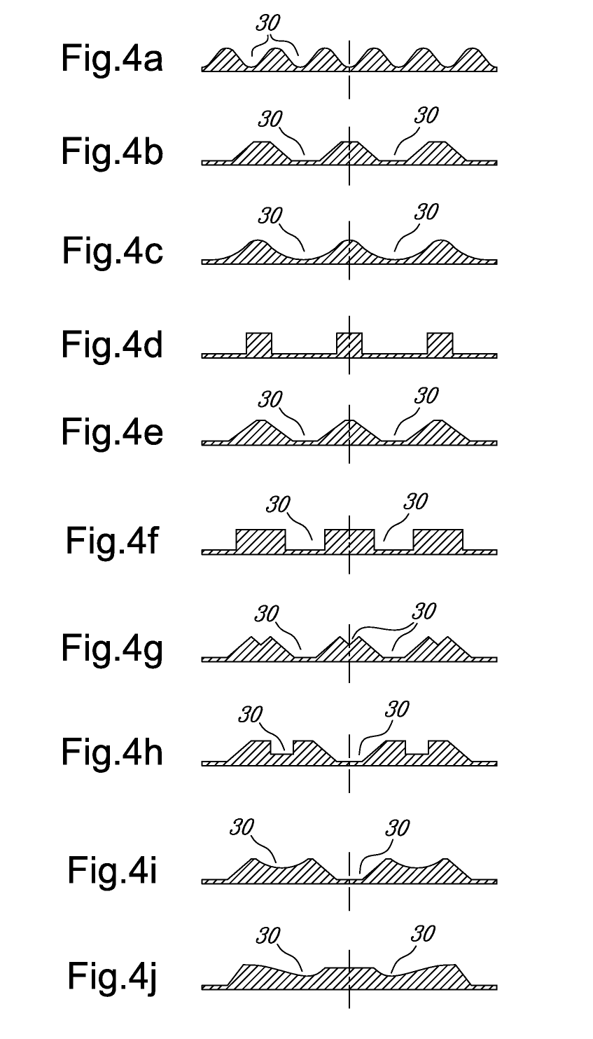

The layout of the respective grooves 30 on each face when placed for example on opposite faces 16, 18 may be different, including the orientation relative to the longitudinal axis (X) of the shaft 10 and/or their shape and thickness (see FIGS. 2c, 2d and 4 for example).

In case of grooves 30 on narrow and wide faces, the grooves can be of a different geometry on each face, and either longitudinally oriented or at an angle on each face.

The density of the grooves 30 on each face may be varied, depending of their respective width, shape and depth for example (see FIG. 4).

FIG. 4 show examples of shapes for grooves 30. By combining different grooves 30, the rigidity of the shaft may be tailored along its length, without increasing the overall weight of the shaft 10 (no addition of material) by varying the modulus of elasticity according to the position along the length of the shaft 10. Grooves 30 may be provided on one first face, the opposite face remaining plain, i.e. without grooves 30, for example.

The grooves 30 may be made in a resin or a filler-reinforced resin, or in a resin with continuous fibers or wires.

Such grooves 30 allow locally tailoring the longitudinal rigidity of the shaft and its resistance to torsion along its length. The general resistance to repeated impact stresses, both torsional stresses and bending stresses, is thus optimized.

The grooves 30 terminate in a landing length 40 allowing recovering the base geometry (see for example FIGS. 1b and 1f) while preventing concentration of stresses which, if allowed to build up, may cause weakening and lead to breaks of the shaft. The landing length 40 may have a rectangular cross sectional envelope (see FIG. 2a), with a slope comprised between ⅙ a 1/12, for example ⅛, from the bottom of the grooves 30 to the surface of the corresponding face (depending on the depth of the grooves, see FIG. 4).

Grooves 30 may further be designed to provide an enhanced grip and adhesion of the gloved hands of the player about the shaft. For example, the grooves 30 may have a geometry allowing a partial penetration of the gloves within relief features formed thereby when the gloved hand of the player holds the shaft.

The present shaft made in high performance composite materials has a high rigidity, so as to match the desired mechanical resistance criteria, and has a flexibility adjusted by removing amounts of material from the surfaces of the face(s) thereof, while maintaining the base rectangular envelope of the shaft unmodified (see FIG. 2b).

According to an embodiment of a method of the present invention, a female mold is provided, comprising ribs on an inner surface thereof, in which a preform is positioned. The ribs of the mold form the deformations towards the inside of the preform, as described hereinabove.

Thus, the present invention comprises removal of matter that results in grooves and results in a decrease of the surface moment of inertia of the shaft relative to the base rectangle envelope, resulting in a reduced rigidity in these parts of the length of the shaft where these grooves are provided. The grooves may be longitudinally oriented relative to the longitudinal axis of the shaft, or at angles relative to the longitudinal axis of the shaft (see FIGS. 2c and 2d for example).

When the grooves are provided in the wide face(s), the resulting grooves increase the flexibility of the overall rigid shaft by reducing the moment of inertia of the cross section of the shaft.

Providing such grooves in the narrow face(s) of the shaft has different results. Grooves on the top narrow face may be used to add longitudinal reinforcements oriented and positioned so as to allow an increased resistance to slashing shots, i.e. transverses impacts on the top narrow face of the opponent's shaft. For example, the grooves may receive a material having a higher strength resistance than that of the material of the walls of the shaft, or may receive embedded longitudinal wires or filaments, either organic, inorganic or metallic for example.

Grooves on bottom and top faces are found to increase the rigidity of the shaft when normally loaded in flexion.

The depth of the grooves and their orientation relative to the longitudinal axis of the shaft may be selected depending on the target rigidity and of a desired friction coefficient between the shaft and the gloved hands of the user.

The width and the depth of the grooves may be selected to adjust the torsional strength of the shaft.

Thus the present invention provides a hockey stick shaft that has a non uniform rigidity along its length. The present invention allows generating a linear variation of the rigidity of the shaft along its length, as most desired by hockey players, while maintaining the performance of the shaft in terms of resistance to fracture when submitted to an impact resulting from a slapshot for example, i.e. without introducing weakened points or regions in the shaft, which may be at risks due to flexion and impact forces during a slapshot, as may occur when using variation of composition of the laminates and/or multiple sections of different layers of materials making the laminated shafts for example, with the result that there is a local reduction of the thickness of the wall of the shaft, which in turn creates stress concentration.

A rigidity variation is generated along the length of the shaft, which does not increase the weight of the shaft and does not introduce weakening zones in the longitudinal axis of the shaft.

The shaft may thus be tailored so as to offer a range of rigidity curves along its length, at a constant overall envelope (perimeter and circumference maintained) and a constant weight.

The shaft is modified by introducing deformations towards the interior of the shaft as grooves, the length of the each groove being adjustable according to a target variation curve of the rigidity of the shaft along its length.

The present method allows maintaining the thickness of the shaft, as well as the total length of reinforcing fibers comprised in the laminated material of the walls of the shaft for example. Only the transverse cross section is varied, along the length of the shaft, and only on a part of the length of the shaft, or along the whole length of the shaft.

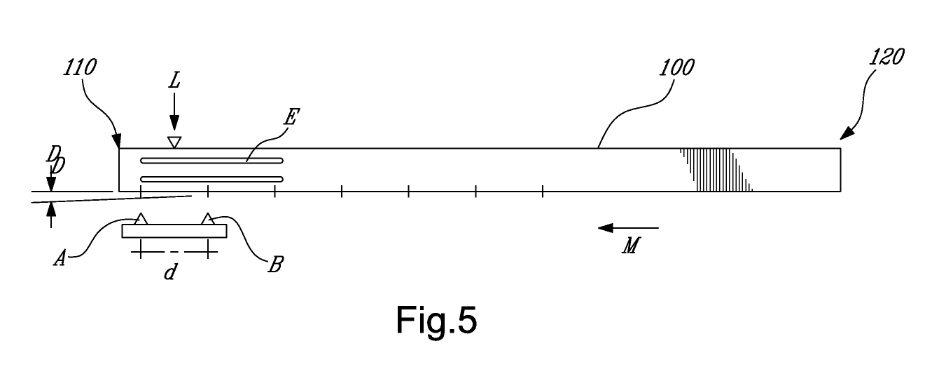

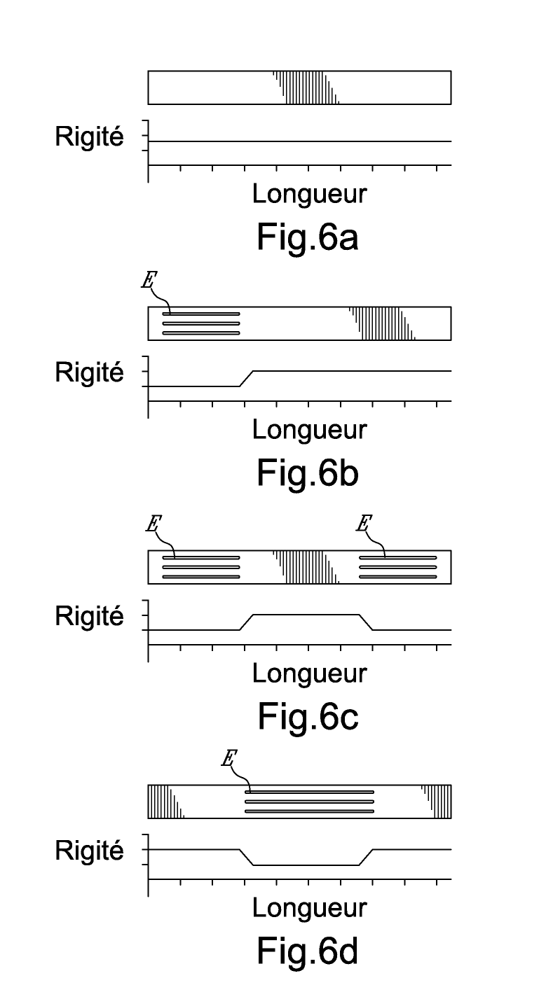

FIGS. 5 and 6 show how the linear rigidity of the shaft may be thus varied.

A shown schematically in FIG. 5, a shaft 100 is positioned on a 3 points flexion test jig set to a distance (d) of 6 inches for example, and measurements are taken along the length of the shaft starting from a first extremity 110 thereof: a load (L) is applied at mid distance between supports A and B until a predetermined fixed deflection (D) of the shaft 100 is reached. As the shaft 100 is moved about the supports A and B (see arrow M), the value of the load to be applied to reach the fixed predetermined deflection (D) is measured along the length of the shaft 100 until the second extremity 120, which allows drawing a curve of the variation of the rigidity of the shaft along its longitudinal axis.

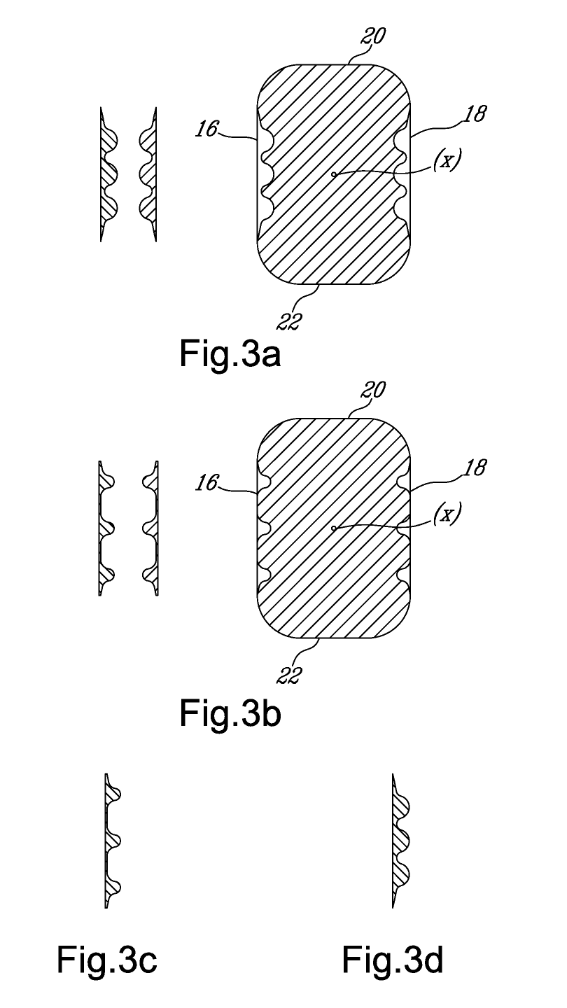

Table I below shows comparative flexural tests on a shaft (laminate of carbon glass and Klevar™ fibers) as known in the art and a shaft (laminate of carbon glass and Klevar™ fibers) with three grooves according to an embodiment of the present invention, in a test set up as described hereinabove, with a span of 4.6 inches instead of 6 inches. Each groove has a length of 50 inches, starting at 4.75 inches from the bottom of the shaft, a depth of 0.0625 inches and a distance center to center of 0.1145 inches (see FIGS. 3b and 3c for example). The grooves are parallel and oriented along the longitudinal axis of the shaft.

TABLE I
COMPARATIVE FLEXURAL FLEXURAL TESTS
COMPARATIVE FLEXURAL TESTS ON HOCKEY SHAFTS

| | SHAFT WITHOUT | SHAFT WITH |
|---|---|---|
| DIS- | GROOVE | GROOVES (3) |
| TANCE | LOAD (POUNDS) | LOAD (POUNDS) |
| 1 | 2971 | 2988 |
| 2 | 4300 | 3531 |
| 3 | 4506 | 3696 |
| 4 | 4610 | 3879 |
| 5 | 4793 | 4421 |
| 6 | 4857 | 4518 |
| 7 | 4823 | 4435 |
| 8 | 4685 | 4251 |
| 9 | 4545 | 4331 |
| 10 | 4790 | 4443 |
| 11 | 4643 | 4450 |

Loads measured at fixed deflection (0.040 inch) and at repetitive
fixed span (4.75 inches)
Span stations: 1-2-3-4-5-6-7-8-9-10-11

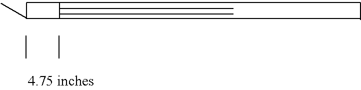

Shaft length: 60 inches

It is shown that, in a zone of the length of the shaft 100 comprising grooves (E) as described hereinabove, the value of the load to be applied to reach the fixed predetermined deflection (D) can be reduced by up to 20% compared to a zone of the length of the shaft 100 deprived of grooves (FIG. 6).

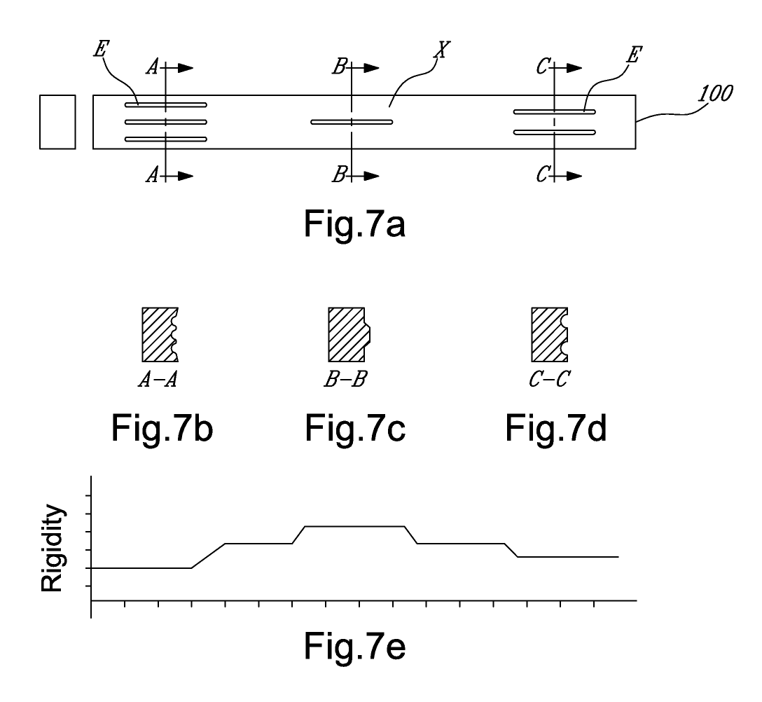

As shown in FIG. 7, a variation of the linear rigidity may further be achieved by alternating grooves (E), i.e. deformations of the shaft towards the inside of the shaft as described hereinabove, with ribs (X), i.e. deformations of the shaft towards the outside of the shaft, molded on the exterior surface of the shaft for example, along the length of the shaft 100.

Although the present invention has been described hereinabove by way of embodiments thereof, it may be modified, without departing from the nature and teachings of the subject invention as recited herein.

What is claimed is:

1. A hockey stick shaft of a generally rectangular cross section and a varying rigidity along a length thereof from a distal end portion thereof to a proximate end portion thereof, comprising an exterior wall, said exterior wall being locally deformed towards an inside of the shaft.

2. The hockey stick shaft of claim 1, wherein said exterior wall comprises at least one deformation towards the inside of the shaft at every 4 to 6 inches along a length of said shaft.

3. The hockey stick shaft of claim 1, wherein said exterior wall has a constant thickness along a length of said shaft.

4. The hockey stick shaft of claim 1, comprising wide faces and narrow faces, at least one of said faces comprising at least one groove integrally embossed within a thickness of said face.

5. The hockey stick shaft of claim 1, comprising wide faces and narrow faces, at least one of said faces comprising at least one groove integrally embossed within a thickness of said face along at least a part of the length of the shaft.

6. The hockey stick shaft of any one of claims 4 and 5, wherein said at least one groove is one of: i) longitudinally oriented and ii) oriented at an angle relative to a longitudinal axis of the shaft.

7. The hockey stick shaft of claim 1, at least two opposite faces thereof each comprising at least one groove integrally embossed within a thickness of said faces.

8. The hockey stick shaft of claim 1, comprising four faces, each faces comprising at least one groove integrally embossed within a thickness thereof.

9. The hockey stick shaft of claim 1, wherein said exterior wall comprises at least one deformation towards the inside of the shaft, said deformation terminating in a landing length at said distal end portion.

10. The hockey stick shaft of claim 1, wherein said exterior wall comprises at least one embossed groove, said groove terminating in a landing length at said distal end portion, said landing length having a rectangular cross sectional envelope, with a slope comprised between ⅙ a 1/12, from a bottom of the groove to an outer surface of the exterior wall.

11. The hockey stick shaft of claim 1, wherein said deformation towards the inside of the shaft comprises a material different from a material of said exterior wall.

12. The hockey stick shaft of claim 1, wherein said deformation towards the inside of the shaft comprises at least one of: wires and filaments.

13. A method for producing a shaft having a varying rigidity along a length thereof, comprising:
providing a shaft in a high rigidity composite material, of a generally rectangular cross sectional envelope; and
selectively forming at least one embossed groove in at least one surface of the shaft.

14. The method of claim 13, wherein said forming at least one embossed groove comprises selecting at least one of: a depth, a width and an orientation relative to a longitudinal axis of the shaft, of the embossed groove.
